(19) United States
(12) Patent Application Publication
(10) Pub. No.: US 2015/0008104 A1
(43) Pub. Date: Jan. 8, 2015

(54) ON-LOAD TAP CHANGER WITH TWO VACUUM INTERRUPTERS AND DRIVE THEREFOR

(71) Applicants: Klaus Hoepfl, Maxhuette-Haidhof (DE); Silke Wrede, Zeitlarn (DE); Christian Kotz, Schorndorf (DE)

(72) Inventors: Klaus Hoepfl, Maxhuette-Haidhof (DE); Silke Wrede, Zeitlarn (DE); Christian Kotz, Schorndorf (DE)

(21) Appl. No.: 14/373,411

(22) PCT Filed: Jan. 15, 2013
(86) PCT No.: PCT/EP2013/050608

§ 371 Date: Jul. 21, 2014

(30) Foreign Application Priority Data
Feb. 16, 2012 (DE) 102012202327.5

(51) Int. Cl. H01H 9/00

(52) U.S. Cl. CPC H01H 9/0027; H01H 9/0038
USPC 200/11 TC

(57) ABSTRACT

An on-load tap changer (1) having at least two vacuum interrupters (3) is disclosed. The on-loader tap changer comprises a selector (7) for selecting a respective winding tap (n, n+1) of a tapped transformer (9), a load changeover switch (5) for changing over from the connected winding tap (n) to the respectively preselected winding tap (n+1), a rotatable drive shaft (11) which is mechanically coupled to the selector (7), and a gear mechanism (15) for operating a moving contact (17) of a respective vacuum interrupter (3). In each case one spindle (19) which can move in a direction of the axis (A) and is coupled to the moving contact (17) can be operated by means of the gear mechanism (15). The invention also relates to a drive for a load changeover switch having at least two vacuum interrupters.

The present invention relates to an on-load tap changer with at least two vacuum interrupters. The on-load tap changer comprises a selector for selection of a respective winding tap of a tapped transformer, a load changeover switch for switching over from the connected winding tap to the respectively preselected winding tap, a rotatable drive shaft that is mechanically coupled with the selector, and a transmission for actuation of a movable contact of a respective vacuum interrupter. The invention also relates to a drive for a load changeover switch with at least two vacuum interrupters.

On-load tap changers of the kind described in the introduction are widely known and familiar in the prior art. They serve for uninterrupted changeover between different winding taps of tapped transformers.

Such on-load tap changers consist of a load changeover switch and a selector arranged thereunder. The selector serves for power-free selection of the respective new winding tap of the tapped transformer that is to be changed over to. The load changeover switch serves for subsequent rapid and uninterrupted changeover from the connected winding tap to the new, preselected winding tap. The entire on-load tap changer is actuated by a motor drive during the changeover. Such a rotating drive shaft continuously moves the selector and at the same time an energy store of the load changeover switch is drawn up. When the energy store is completely drawn up, i.e. stressed, it is unlatched, releases its energy abruptly and actuates the load changeover switch in a space of time of milliseconds (ms).

In the case of the described load changeover the load changeover switch executes a specific switching sequence, i.e. different switch contacts and resistance contacts are actuated in a specific sequence in time in succession or in overlapping manner. In that case, the switch contacts serve for direct connection of the respective winding tap with the load diverter and the resistance contacts for temporary connection, i.e. bridging over by means of one or more switch-over resistances. The vacuum interrupters are advantageously used as switching elements for the load changeover. This is due to the fact that the use of vacuum is interrupters for the load changeover prevents arcing in the oil and thus oil contamination of the load changeover switch oil, as described in, for example, German Patent Specifications DE 195 10 809 [U.S. Pat. No. 5,834,717] and DE 40 11 019 [U.S. Pat. No. 5,107,200] and German published specifications DE 42 31 353 and DE 10 2007 004 530.

An on-load tap changer of that kind with vacuum interrupters is also disclosed in German published specification DE 10 2009 043 171 A1. Here, a load changeover switch carries a drive shaft with at least one cam disk. The cam disk has several cams, wherein two cams arranged at the cam disk at an end have a profile that departs from a circular shape, in the form of lobes at which a respective roller that is connected with a vacuum interrupter by way of a tip lever and that scans the profiled contour of the respective cam, is guided in contact-coupled manner.

The object of the invention is therefore to create a space-saving on-load tap changer with at least two vacuum interrupters that at the same time ensures reliable and rapid load changeover without susceptibility to disturbance and that makes possible a lengthy service life.

This object is fulfilled by an on-load tap changer with at least two vacuum interrupters according to claim 1.

The object of the invention is additionally to create a drive for a load changeover switch with at least two vacuum interrupters that ensures faultless, reliable and rapid load changeover.

This object is fulfilled by a drive for a load changeover is switch with at least two vacuum interrupters according to claim 9.

The on-load tap changer according to the invention with at least two vacuum interrupters comprises a selector for selection of a respective winding tap of a tapped transformer and a load changeover switch for changing over from the connected winding tap to the respectively preselected winding tap. Moreover, the on-load tap changer comprises a rotatable drive shaft that is mechanically coupled with the selector, and a transmission for actuation of a movable contact of a respective vacuum interrupter.

According to the invention a respective spindle that is movable in the direction of the axis and coupled with the movable contact and that is actuatable by way of the transmission, is provided.

It is to be noted that the movable contact consists of an upper tappet and further components that are present for electrical transmission. In addition, each vacuum interrupter has a lower tappet, i.e. the axial movement of the spindle is transmitted to the movable contact so that the movable contact can be coupled with the lower tappet. Thus, electrical conductivity is then given and the circuit is closed. Opening of the circuit takes place in opposite sense, i.e. movable contact and lower tappet in each vacuum interrupter are distanced from one another. A more detailed description and illustration of the movable contact and the lower tappet in each vacuum interrupter has been dispensed with, since these are widely known and familiar in the prior art.

The transmission comprises at least one cam disk, a spindle nut and at least one follower constructed on the spindle nut in the direction of the axis. The spindle is mounted to be axially fixed, but rotatable. The at least one follower, also termed pin or follower pin in the machine field, is so constructed on the spindle nut that during rotational movement of the spindle nut it is equally set into a rotational movement, thus entrained. The spindle nut in turn converts the rotational movement into an axial movement of the spindle.

In order to appropriately change a continuous rotational movement of the drive shaft into intermittent rotational movements or the number of rotational movements of the spindle nut for a load changeover of a respective vacuum interrupter, in a first form of embodiment the at least one cam disk carries at least one lobe, i.e. the cam disk in that case has a profile departing from its circular shape. Thus, during rotational movement of a cam disk at least one follower co-operates with the lobe, in particular in such a manner that the at least one follower during rotational movement of the cam disk engages in the lobe. The follower is in that way entrained in the lobe until it exits again from the lobe.

In a further form of embodiment, in order to change the rotational movements during load changeovers a first cam disk carries a first lobe and a second cam disk carries a second lobe. The first lobe then co-operates with the at least one first follower and the second lobe co-operates with the at least one second follower of the spindle nut.

The transmission described in the two forms of embodiment is, in particular, a cam step transmission.

In a further form of embodiment at least one bearing, is which is constructed as a roller bearing, slide screw and/or ball screw, for the spindle and the spindle nut is provided. The at least one bearing is preferably a ball screw. Ball screws are distinguished by the fact that rollable bodies in the form of balls roll in guide grooves between the spindle nut and the spindle and thus ensure movements with a high level of efficiency. By comparison with conventional slide screws, or so-called roller screws, through the point contact of the balls the drive power is reduced, wear of the rollable body guide tracks is lessened, an achievable travel speed is increased and a higher positional accuracy is made possible.

In a further form of embodiment rotational securing means, which secure the spindle against rotation, are provided. These rotational securing means can be, for example, a roller bearing or axial securing means as a sleeve. It is obvious to the expert that other rotational securing means are also conceivable, since various forms of securing against rotation of a spindle are disclosed in the prior art.

In a further, preferred form of embodiment a compression spring is arranged between the spindle and the movable contact and mechanically biases the movable contact in the direction of the axis of the load changeover switch. This is due to the fact that in the case of a load changeover numerous small discharges take place between the movable contact and the spindle, so that mutual material removal, also termed contact or electrode burning away, occurs at the two components. The compression spring shall in that case provide compensation for the change in spacing between the contacts due to material removal and thus create constant conditions for a load changeover switch.

In order to provide compensation for the change, which arises due to contact burning away, in the axial path that each movable contact covers in its axial movement caused by the force flow produced by the spindle there is additionally provided, in a bearing unit for mounting of the movable contact, axial play between the bearing unit and the movable contact.

An advantage of the on-load tap changer according to the invention is that in the case of load changeover merely axial movements of each movable contact and each spindle coupled therewith have to be executed. A more rapid, reliable and tilt-free stroke for opening and closing the vacuum interrupters is thus possible. At the same time, due to the above-described increased travel speed of the spindle a more rapid stroke is equally guaranteed.

A further advantage of the on-load tap changer according to the invention is that through the axial arrangement of each movable contact and spindle further components of mechanical switches, such as, for example, tip levers, interrupters, etc., can be eliminated.

The transmission according to the invention for a load changeover switch with at least two vacuum interrupters comprises a rotatable drive shaft and a transmission for actuating a movable contact of a respective vacuum interrupter. A respective spindle is mechanically coupled with each movable contact, wherein the spindle is rotatable by way of the transmission so that a movement of the contact in the direction of an axis of the load changeover switch can be produced. The transmission comprises at least one cam disk that each carry at least one lobe, a spindle nut and at least one follower that is formed on the spindle nut in the direction of the axis and that co-operates with the at least one lobe of the respective cam disk. Advantageously, due to the axial arrangement of each movable contact and spindle, i.e. forces no longer have to be diverted by way of further mechanical switches, a fault-free, reliable and rapid load changeover is possible.

The invention and the advantages thereof are described in more detail in the following with reference to the accompanying drawings, in which:

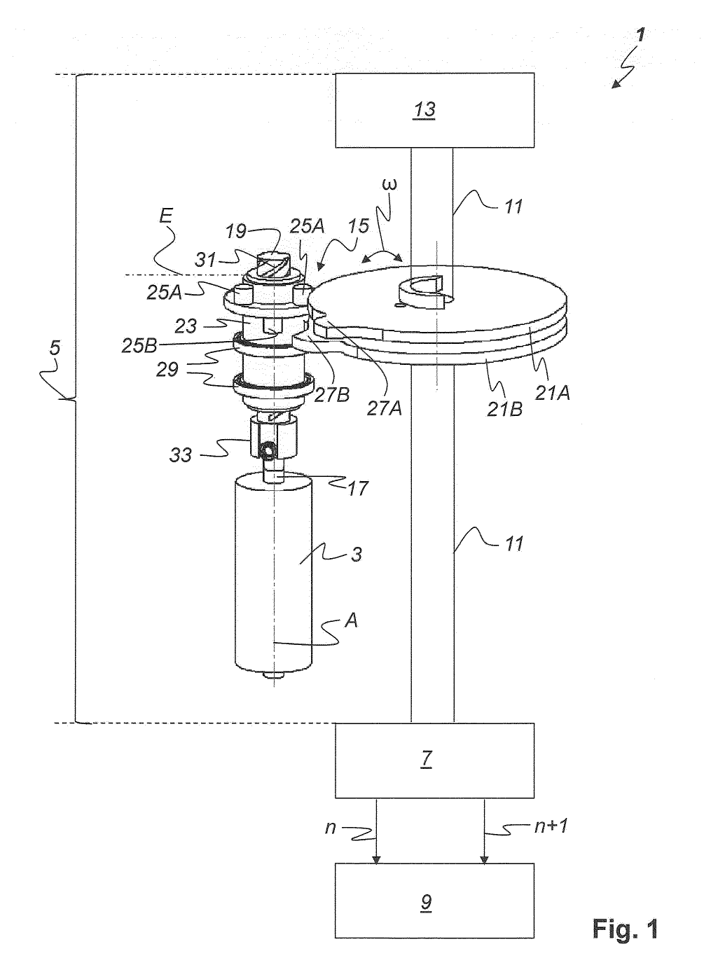

FIG. 1 shows a schematic perspective view of one form of embodiment of the on-load tap changer according to the invention, with an open circuit;

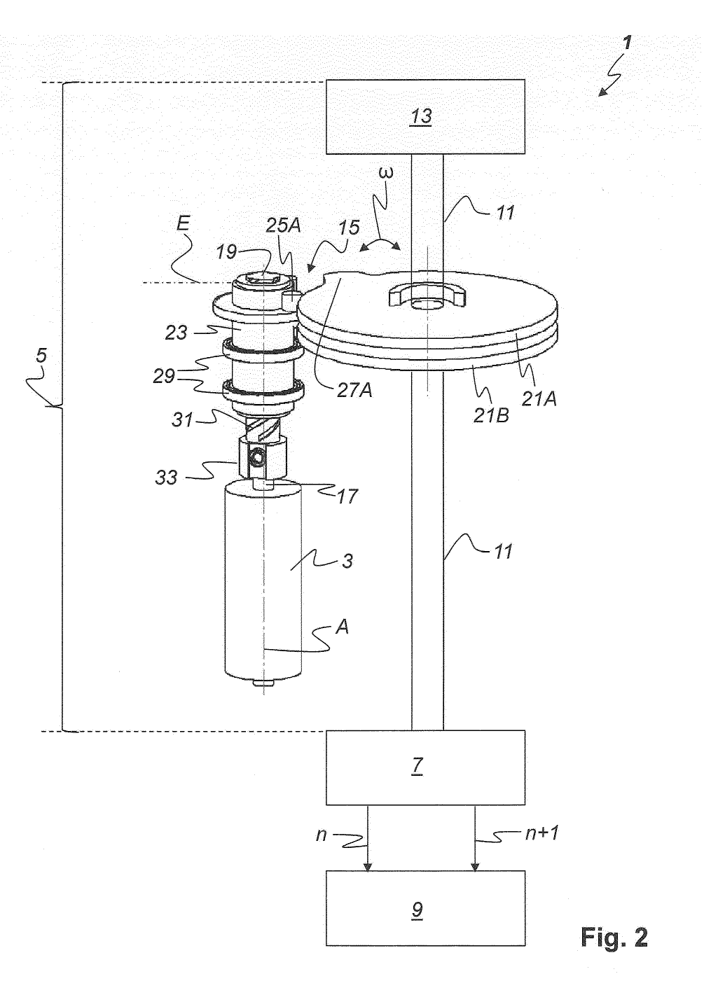

FIG. 2 shows a schematic perspective view of the on-load tap changer according to FIG. 1, with a closed circuit;

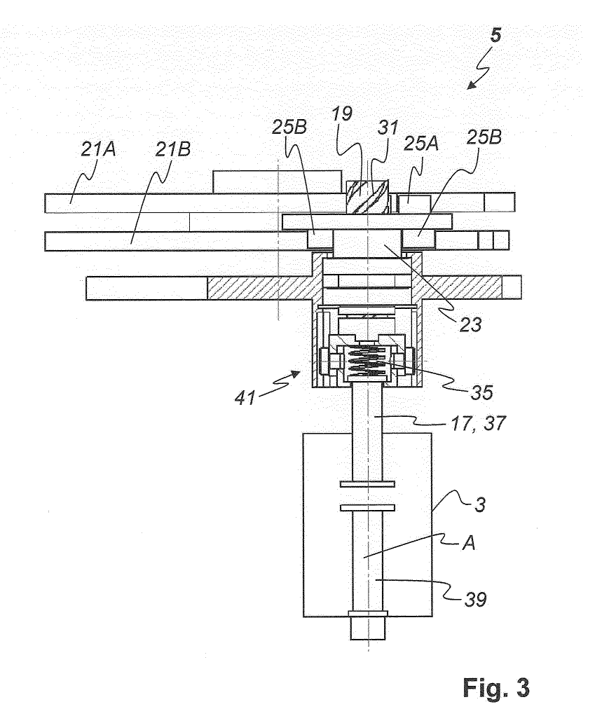

FIG. 3 shows a side view of a load changeover switch of the on-load tap changer according to the invention, with an open circuit, wherein a compression spring is arranged between a spindle and the movable contact; and

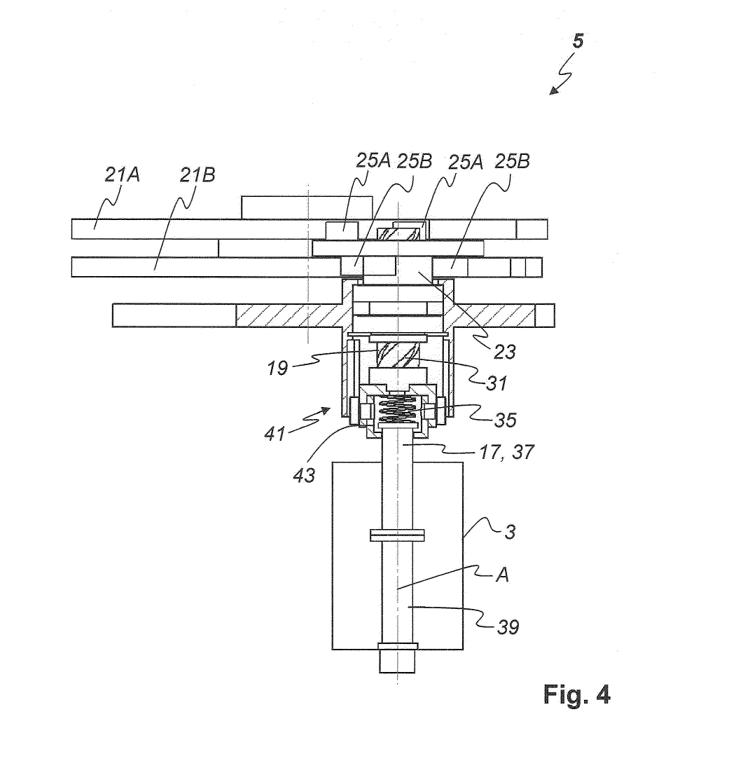

FIG. 4 shows a side view of the load changeover switch according to FIG. 3, with a closed circuit.

Identical reference numerals are used in the figures for the same or equivalent elements of the invention. In addition, for the sake of clarity only those reference numerals are depicted in the individual figures that are required for the description of the respective figure.

FIG. 1 shows a schematic perspective view of one form of embodiment of the on-load tap changer 1 according to the invention. The on-load tap changer 1 shows here, for reasons of clarity, only one vacuum interrupter 3, wherein, however, the on-load tap changer 1 always has at least two vacuum interrupters 3. A selector 7 serves for selection of a respective winding tap n, n+1 of a tapped transformer 9. A load changeover switch 5 produces the switching over from the connected winding tap n to the respective preselected winding tap n+1. In addition, the on-load tap changer 1 comprises a rotatable drive shaft 11. A transmission 15, which is connected with the drive shaft 11, serves for actuation of a movable contact 17 (illustrated in detail in FIG. 3 and FIG. 4) that is realized in a respective vacuum interrupter 3. The drive shaft 11 is mechanically coupled with the selector 7 and moves this continuously. At the same time, an energy store 13 of the load changeover switch 5 is pulled up. When the energy store 13 is completely pulled up, it is unlatched, abruptly releases its energy and actuates the load changeover switch 5 by way of the drive shaft 11 in the millisecond range.

According to the invention, a respective spindle 19 movable in the direction of the axis A and coupled with the movable contact 17 is provided, the spindle being actuatable by way of the transmission 15. As shown in FIG. 1, the spindle 19 projects in the direction of the axis A by comparison with FIG. 2 beyond a plane E, so that the movable contact 17 is distanced from a lower tappet 39 of the vacuum interrupter 3 (see, with respect thereto,

FIG. 3). The circuit is thus open and no current flows.

In this form of embodiment the transmission 15 has a first cam disk 21A and a second cam disk 21B, a spindle nut 23 and three followers 25A, 25B formed on the spindle nut 23 in the direction of the axis A. However, it is also conceivable that further forms of embodiment have more than only two cam disks 21A, 21B or more or less than three followers 25A, 25B formed on the spindle nut 23.

In order to change continuous rotational movements of the drive shaft 11 into rotational movements of the spindle nut 23 for a load changeover the first and second cam disks 21A, 21B respectively carry a first lobe 27A and second lobe 27B. Other forms of embodiment can also have more than only one lobe 27A, 27B at each cam disk 21A, 21B.

When a rotational movement w takes place the first lobe 27A of the first cam disk 21A thus co-operates with at least one of the two followers 25A and the second lobe 27B of the second cam disk 21B co-operates with the second follower 25B of the spindle nut 23. Each follower 25A, 25B is in that way entrained in the respective lobe 27A, 27B during a rotational movement w of the first and second cam disks 21A, 21B until it exits again from the respective lobe 27A, 27B.

Moreover, at least one bearing 29 for the spindle 19 and the spindle nut 23 is provided. The bearing 29 is advantageously a ball screw. Ball screws are distinguished by the fact that rollable bodies (not illustrated) in the form of balls roll in guide grooves 31 between the spindle nut 23 and the spindle 19 and thus ensure axial movements with a high level of efficiency.

A further form of embodiment of the on-load tap changer 1 according to the invention, as also shown in FIG. 1, provides rotational securing means 33 so that the spindle 19 is secured against rotation. Since rotational securing means 33 for a spindle 19 are known to the expert, description thereof is dispensed with.

FIG. 2 shows a schematic perspective view of the on-load tap changer 1 according to FIG. 1 with a closed circuit. This is due to the fact that in the direction of the axis A the spindle 19 is, by comparison with FIG. 1, at the level of the plane E, i.e. the movable contact 17 is mechanically coupled with the lower tappet 39 of the vacuum interrupter 3 (see, with respect thereto, FIG. 4). The circuit is thus closed and current flows.

Further features that can be inferred in this illustration, inclusive of the reference numerals thereof, are identical with the on-load tap changer 1 according to FIG. 1 and are therefore to be inferred therefrom.

FIG. 3 shows a side view of a load changeover switch 5 of the on-load tap changer 1 according to the invention (see FIG. 1) with an open circuit, wherein a compression spring 37 is arranged between a spindle 19 and the movable contact 17. The compression spring 37 is provided for the purpose of mechanically biasing the movable contact 17 in the direction of the axis A of the load changeover switch 5 and electro-erosion is avoided.

As already described, the electrical contact 17 is is constructed from an upper tappet 37 and further components (not illustrated) that are present for electrical transmission. A more precise description of the electrical contact 17 was dispensed with since forms of construction are known in the prior art. FIG. 3 also shows that a lower tappet 39 is constructed in each vacuum interrupter 3. Since, the movable contact 17 is here distanced from the lower tappet 39 of the vacuum interrupter 3, the current circuit is open.

Further features, which can be inferred here, inclusive of the reference numerals thereof, are identical with the preceding FIGS. 1 and 2 and are therefore to be inferred therefrom.

FIG. 4 shows a side view of the load changeover switch 5 according to FIG. 3 with a closed circuit, since the movable contact 17 is mechanically coupled with the lower tappet 39 of the vacuum interrupter 3. Current thus flows. In order to compensate for the change, which arises due to contact burning away, in the axial travel that each contact 17 covers during its axial movement produced by force flow introduced by the spindle 19 there is provided in a bearing unit 41 for mounting of the movable contact 17 an axial play 43 between the bearing unit 41 and the movable contact 17.

The invention was described with reference to a preferred embodiment. However, it is obvious to any expert that modifications and changes can be undertaken without in that case departing from the scope of protection of the appended claims. The embodiments explained in the preceding serve merely for description of the claimed teaching, but there is no restriction to the embodiments.

Reference numeral list:

| | |
|---|---|
| 1 | on-load tap changer |
| 3 | vacuum interrupter |
| 5 | load changeover switch |
| 7 | selector |
| 9 | tapped transformer |
| 11 | drive shaft |
| 13 | energy store |
| 15 | transmission |
| 17 | movable contact |
| 19 | spindle |
| 21A, 21B | first, second cam disk |
| 23 | spindle nut |
| 25A, 25B | follower |
| 27A, 27B | first, second lobe |
| 29 | bearing |
| 31 | guide groove |
| 33 | rotational securing means |
| 35 | compression spring |
| 37 | upper tappet |
| 39 | lower tappet |
| 41 | bearing unit |
| 43 | axial play |
| A | axis |
| E | plane |
| ω | rotational movement |
| n | connected winding tap |
| n + 1 | preselectable winding tap |

1. An on-load tap changer comprising:
at least two vacuum interrupters,
a selector for selecting a respective winding tap of a tapped transformer,
a load changeover switch for switching over from the connected winding tap to the respective preselected winding tap,
a rotatable drive shaft mechanically coupled to with the selector, and
a transmission for actuating a movable contact of a respective vacuum interrupter, and
a respective spindle movable in the direction of the axis, coupled with the movable contact, and actuatable by the transmission.

2. The on-load tap changer according to claim 1, wherein the transmission comprises:
at least one cam disk,
a spindle nut and
at least one follower formed on the spindle nut in the direction of the axis.

3. The on-load tap changer according to claim 2, wherein the at least one cam disk carries at least one lobe so that when a rotational movement of a cam disk takes place at least one follower co-operates with the lobe.

4. The on-load tap changer according to claim 2, wherein a first cam disk carries a first lobe and a second cam disk carries a second lobe, and wherein the first lobe co-operates with the at least one first follower and the second lobe co-operates with the at least one second follower of the spindle nut.

5. The on-load tap changer according to claim 1, wherein the transmission is a cam step transmission.

6. The on-load tap changer according to claim 1, wherein further comprising:
at least one roller bearing, slide screw and/or ball screw for the spindle and the spindle nut.

7. The on-load tap changer according to claim 1, further comprising:
rotational securing means securing the spindle against rotation.

8. The on-load tap changer according to claim 1, further comprising:
a compression spring between the spindle and the movable contact and mechanically biasing the movable contact axially of the load changeover switch.

9. In a drive for a load changeover switch with at least two vacuum interrupters, a rotatable drive shaft and a transmission for actuating a movable contact of a respective vacuum interrupter, the improvement comprising:
a respective spindle is mechanically coupled with the movable contact and is rotatable by the transmission for axial movement of the contact of the load changeover switch.

10. The drive according to claim 9, wherein the transmission comprises:
at least one cam disk that carries at least one lobe,
a spindle nut, and
at least one follower extending axially on the spindle nut cooperating with the at least one lobe of the respective cam disk.
